(19) United States
(12) Patent Application Publication
(10) Pub. No.: US 2016/0216557 A1
(43) Pub. Date: Jul. 28, 2016

(54) LIQUID CRYSTAL DISPLAY AND METHOD OF MANUFACTURING THE SAME

(71) Applicant: Samsung Display Co., Ltd., Yongin-City (KR)

(72) Inventors: Soon Joon RHO, Yongin-City (KR); Sun Young KWON, Yongin-City (KR); Kyung Min KIM, Yongin-City (KR); Keun Chan OH, Yongin-City (KR)

(21) Appl. No.: 14/922,944

(22) Filed: Oct. 26, 2015

(30) Foreign Application Priority Data
Jan. 22, 2015 (KR) 10-2015-0010784

(51) Int. Cl. G02F 1/1335; G02F 1/1368

(52) U.S. Cl. CPC G02F 1/133528; G02F 1/1368; G02F 1/1336; G02F 2001/133614

(57) ABSTRACT

There is provided a liquid crystal display (LCD). The LCD includes a thin film transistor (TFT) disposed on a first substrate, a pixel electrode connected to the TFT, a second substrate that faces the first substrate, a liquid crystal layer formed between the first substrate and the second substrate, a light emitting layer positioned between the liquid crystal layer and the second substrate, a first polarizing plate positioned on a rear surface of the first substrate and including a collimating film and a second polarizing plate positioned between the light emitting layer and the liquid crystal layer.

### CROSS-REFERENCE TO RELATED APPLICATION

This application claims priority to and the benefit of Korean Patent Application No. 10-2015-0010784, filed on Jan. 22, 2015, in the Korean Intellectual Property Office, the entire contents of which are incorporated herein by reference in their entirety.

### BACKGROUND

1. Field

The present inventive concept relates to a method of manufacturing a liquid crystal display (LCD).

2. Description of the Related Art

A liquid crystal display (LCD) is a display device that obtains a desired image signal by applying an electric field with controlled intensity to liquid crystal having an anisotropic dielectric constant, which is formed between two substrates, to control an amount of light that passes through the substrates. The LCD includes a liquid crystal panel for displaying an image and a backlight unit for providing light to the liquid crystal panel.

The liquid crystal panel includes a first substrate on which a plurality of thin film transistors (TFT) and a pixel electrode are formed, a second substrate on which a color filter and a common electrode are formed, and a liquid crystal layer formed between the two substrates. Upper and lower polarizing plates for polarizing the light provided by the backlight unit in a specific direction may be respectively arranged on upper and lower surfaces of the liquid crystal panel.

Since the light generated by the backlight unit is not polarized, the light may be polarized in a desired direction after passing through the liquid crystal panel and the upper polarizing plate.

### SUMMARY

An embodiment of the present inventive concept relates to a liquid crystal display (LCD) capable of minimizing crosstalk to improve picture quality and a method of manufacturing the same.

An LCD according to an embodiment of the present inventive concept includes a thin film transistor (TFT) disposed on a first substrate, a pixel electrode connected to the TFT, a second substrate that faces the first substrate, a liquid crystal layer formed between the first substrate and the second substrate, a light emitting layer positioned between the liquid crystal layer and the second substrate, a first polarizing plate positioned on a rear surface of the first substrate and including a collimating film, and a second polarizing plate positioned between the light emitting layer and the liquid crystal layer.

A method of manufacturing an LCD according to another embodiment of the present inventive concept includes forming a TFT and a pixel electrode connected to the TFT on a first substrate, forming a first polarizing plate including a collimating film on a surface of the first substrate, forming a light emitting layer on the second substrate, forming a second polarizing plate on the light emitting layer, and adhering the first substrate and the second substrate.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is an exploded perspective view of a liquid crystal display (LCD) according to an embodiment of the present inventive concept;

FIG. 2 is a plan view schematically illustrating a pixel structure of the LCD of FIG. 1;

FIG. 3 is a cross-sectional view taken along the line I-I′ of the LCD of FIG. 1;

FIG. 4 is a cross-sectional view of the second polarizing plate of FIGS. 3; and

FIGS. 5, 6, 7 and 8 are cross-sectional views sequentially illustrating a method of manufacturing the upper display plate of FIG. 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will full convey the scope of the example embodiments to those skilled in the art.

Like reference numerals refer to like elements throughout. In the drawing figures, dimensions may be exaggerated for clarity of illustration.

It will also be understood that when an element is referred to as being “on” another element, it can be directly on the other element, or intervening elements may also be present between the element and the another element.

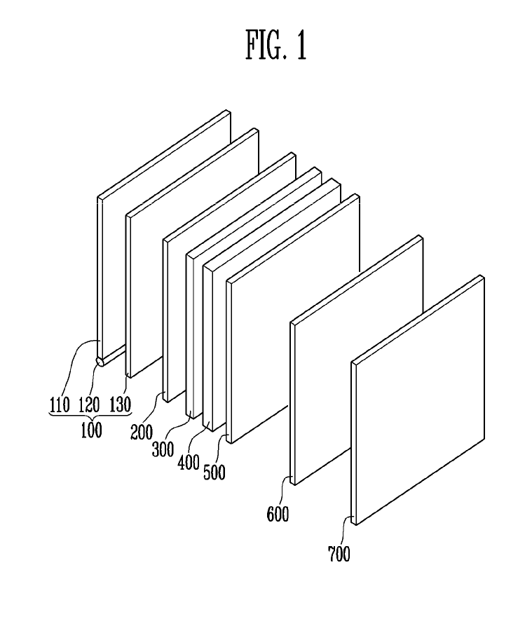

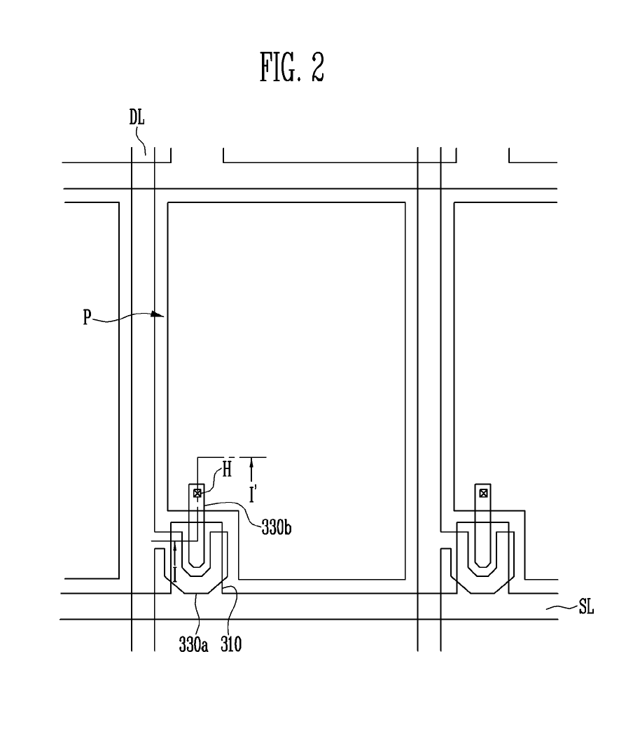

FIG. 1 is an exploded perspective view of a liquid crystal display (LCD) according to an embodiment of the present inventive concept. FIG. 2 is a plan view schematically illustrating a pixel structure of the LCD of FIG. 1. FIG. 3 is a cross-sectional view taken along the line I-I′ of the LCD of FIG. 1.

Referring to FIGS. 1 to 3, the LCD according to the embodiment of the present inventive concept includes a lower display substrate 10, an upper display substrate 20, a liquid crystal layer 400 formed between the two display substrates 10 and 20, and a backlight unit 100 for providing light to the lower display substrate 10.

First, the lower display substrate 10 will be described.

The lower display substrate 10 includes a first substrate 300 on which a plurality of thin film transistors (TFT) and a pixel electrode 350, and a first polarizing plate 200 are disposed on a front surface and a rear surface of the first substrate 300, respectively.

A scan line SL to which scan signals are supplied, a data line DL that intersects the scan line SL and to which data signals are supplied, a TFT formed at an intersection of the scan line SL and the data line DL, and the pixel electrode 350 electrically connected to the TFT are disposed on the first substrate 300. A pixel region P may be defined by the scan line SL and the data line DL.

The pixel region P may have more than one sub-pixel regions having different transmittance in order to improve visibility.

The TFT includes a gate electrode 310 disposed on the first substrate 300, a gate insulating layer 315 disposed on the gate electrode 310, a semiconductor layer 320 formed on the gate insulating layer 315, source electrode 330a and drain electrode 330b formed on the semiconductor layer 320, a protective layer 340 formed on the source electrode 330a and the drain electrode 330b, and the pixel electrode 350 formed on the protective layer 340 to be electrically connected to the drain electrode 330b.

The first substrate 300 as a material for forming a device may have high mechanical strength or dimensional stability. The material of the first substrate 300 may be, for example, a glass plate, a metal plate, a ceramic plate, or plastic (polycarbonate resin, polyester resin, epoxy resin, silicon resin, or fluoride resin). However, the present inventive concept is not limited thereto.

The first substrate 300 may have a thickness of about 200 μm to about 500 μm. When the first substrate 300 is used to a large TV bigger than 55 inches, a thickness of the first substrate 300 may be no more than 200 μm. According to the embodiment of the present inventive concept, the thickness of the first substrate 300 may be equal to or less than 200 μm.

The gate electrode 310 may be a single layer formed of a metal material such as molybdenum (Mo), titanium (Ti), chrome (Cr), tantalum (Ta), tungsten (W), aluminum (Al), copper (Cu), neodymium (Nd), and scandium (Sc) or an alloy material using the above metal materials as main components or may be formed by stacking layers formed of metal materials such as Mo, Ti, Cr, Ta, W, Al, Cu, Nd, and Sc or alloy materials using the above metal materials as main components.

The gate electrode 310 may be a multi-layered structure, for example, the gate electrode 310 may be a double-layered structure in which a Mo layer is stacked on an Al layer, a double-layered structure in which the Mo layer is stacked on a Cu layer, a double-layered structure in which a Ti nitride layer or a Ta nitride is stacked on the Cu layer, and a double-layered structure in which the Ti nitride layer and the Mo layer are stacked.

The gate insulating layer 315 is a single inorganic insulating layer such as a silicon oxide layer, a silicon oxy-nitride layer, a silicon nitride layer, and a tantalum oxide layer or is formed by stacking inorganic insulating layers such as a Silicon oxide layer, a silicon oxy-nitride layer, a silicon nitride layer, and a tantalum oxide layer.

The semiconductor layer 320 has a structure in which an active layer 320a formed of an amorphous silicon material and an ohmic contact layer 320b formed of an impurity doped amorphous silicon material are sequentially stacked.

The source electrode 330a and the drain electrode 330b may be a single-layered structure of one selected from the group consisting of molybdenum (Mo), tungsten (W), aluminum neodymium (AlNd), titanium (Ti), Aluminum (Al), silver (Ag), and an alloy of the above element. The source electrode 330a and the drain electrode 330b may be a multi-layered structure of Mo, W, AlNd, Ti, Al, Ag, and the alloy of the above element in order to reduce line resistance.

The protective layer 340 includes a contact hole H that exposes a part of the drain electrode 330b to the outside and may be formed of one insulating material selected from an inorganic insulating material and an organic insulating material.

The pixel electrode 350 is electrically connected to the drain electrode 330b of the TFT through the contact hole H. The pixel electrode 350 may be formed of a transparent metal material such as indium-tin-oxide (ITO) and indium-zinc-oxide (IZO).

A first alignment layer 360 for aligning liquid crystal is formed on the pixel electrode 350.

The first polarizing plate 200 is formed between the first substrate 300 including the TFT and the backlight unit 100.

The first polarizing plate 200 may be a film that includes a collimating film capable of collimating the light provided by the backlight unit 100 in a specific direction without diffusing the light.

The first polarizing plate 200 including the collimating film concentrates the light provided by the backlight unit 100 without diffusing the light to polarize the light in a specific direction.

Hereinafter, the upper display substrate 20 will be described.

The upper display substrate 20 includes a second substrate 700 on which a black matrix 710 disposed on the second substrate 700, a light emitting layer 600 formed on the second substrate 700, a second polarizing plate 500 formed on the light emitting layer 600, a common electrode 480 formed on the second polarizing late 500, and a second alignment layer 450 formed on the common electrode 480 are disposed.

The second substrate 700 may be formed of glass or plastic like the first substrate 300.

The light emitting layer 600 is disposed under the second substrate 700 and includes an optical conversion material. The optical conversion material may be a phosphor or non-phosphors such as quantum dots and quantum rods.

The quantum dots and quantum rods are nano-sized semiconductor materials having quantum confinement effect and generate stronger light than the phosphors in a narrow wavelength range.

Specifically, since a wavelength of light obtained from the quantum dots is determined by a size of the quantum dots, light of a desired wavelength may be obtained by controlling the size of the quantum dots. Because the quantum dots are transited only from a bottom vibration state of a conduction band to a bottom vibration state of a valence band, a light emitted from the quantum dots is almost single-colored light.

Due to the above characteristic of the quantum dots, when the light provided by the backlight unit 100 passes through the light emitting layer 600, light having desired colors (red, green, and blue) which have improved brightness may be obtained.

The second polarizing plate 500 is disposed under the second substrate 700 and the light that passes through a liquid crystal layer 400 is polarized in a specific direction.

The second polarizing plate 500 may include magnetic particles 530 in order to secure the polarization characteristic as illustrated in FIG. 4.

Specifically, the second polarizing plate 500 includes a transparent substrate 510 and a magnetic material layer 520 arranged on the transparent substrate 510. The magnetic material layer 520 may be formed by dispersing core-shell structured magnetic particles 530 into an insulating material in a paste state such as “gel” without agglomeration. The insulating material may be thinly coated on the transparent substrate 510 and hardening the coated insulating material to obtain the second polarizing plate 500. The second polarizing plate 500 may be formed by immersing the core-shell structured magnetic particles into a solution and thinly spin coating or deep coating the transparent substrate 510 with the solution and hardening the coated solution.

In particular, the magnetic material layer 520 includes the core-shell structured magnetic particles 530. The magnetic particles 530 include cores 530a formed of a conductive magnetic material and insulating shells 530b that surround the cores 530a. The magnetic particles 530 may be spherical, oval, rectangular, cubic, elliptical, or cylinder. However, the present inventive concept is not limited thereto.

Any material having conductive and magnetic characteristics may be used as the cores 530a of the magnetic particles 530. For example, a ferromagnetic or super paramagnetic metal such as cobalt (Co), iron (Fe), and nickel (Ni) or an alloy of the above such as CoₓPt_{y} and Fe_{y}Pt_{z} (here, x, y, and z represent component ratios), a paramagnetic metal such as Ti, Al, barium (Ba), Pt, natrium (Na), strontium (Sr), magnesium (Mg), dysprosium (Dy), manganese (Mn), and gadolinium (Gd) or an alloy of the above, a semi-magnetic metal such as Ag or Cu or an alloy of the above, chrome (Cr) that changes into a paramagnetic substance at a temperature of no less than the Neel temperature and an anti-ferromagnetic metal, or a ferromagnetic substance such as MnZn(Fe₂O₄)₂, MnFe₂O₄, Fe₃O₄, Fe₂O₃, Sr₈CaRe₃Cu₄O₂₄, CoₓZr_{y}Nb_{z}, NiₓFe_{y}Nb_{z} and CoₓZr_{y}Nb_{z}Fe_{y} having small electrical conductivity and high magnetic susceptibility may be used as the material of the cores 530a.

According to the embodiment of the present inventive concept, an inorganic nano material including Fe3O4 that is a ferromagnetic substance may be used as the material of the cores 530a of the magnetic particles 530.

On the other hand, in a core-shell structured magnetic particle 530, a shell 530b prevents two cores 530a from agglomerating or directly contacting each other. For this purpose, a transparent insulating material such as SiO₂ or ZrO₃ may be applied to the shell 530b that surrounds the core 530a.

In addition, in the magnetic material layer 520, a space formed between the magnetic particles 530 may be filled with a light hardening material 520a such as polymer. The light hardening material 520a is hardened by irradiating ultraviolet (UV) rays in a process of forming the magnetic material layer 520 to fix the magnetic particles 530 in the magnetic material layer 520.

In the magnetic material layer 520 of the second polarizing plate 500, arrangement of the magnetic particles 530 is controlled in accordance with intensity of a magnetic field (or an electric field) applied from the outside so that the polarization characteristic of the light that passes through the liquid crystal layer 400 may be improved.

A common electrode 480 is formed on the second polarizing plate 500 and the second alignment layer 450 for pre-tilting liquid crystal molecules of the liquid crystal layer 400 at a specific angle with a first alignment layer 360 is formed on the common electrode 480.

The liquid crystal layer 400 may include the liquid crystal molecules. The alignment method of the liquid crystal molecule varies in accordance with the form of the pixel electrode 350 provided on the first substrate 300.

For example, when the pixel electrode 350 is designed to include an element such as a slit for controlling an alignment direction, the liquid crystal layer 400 may include vertically aligned (VA) liquid crystal molecules.

In addition, when the pixel electrode 350 does not include an element for controlling the alignment direction, the liquid crystal layer 400 may include liquid crystal molecules having an anti-parallel alignment direction.

The backlight unit 100 includes a light source 120 formed of a light emitting diode (LED), a light guiding plate 110 for converting spot light emitted from the light source 120 into surface light to irradiate the lower display substrate 10 with the converted light, and an optical sheet 130 for changing characteristics of the light emitted from the light guiding plate 110.

The light generated by the light source 120 of the backlight unit 100 travels to the first polarizing plate 200 through the light guiding plate 110 and the optical sheet 130. Since the first polarizing plate 200 includes a collimating film, the light provided by the optical sheet 130 is not diffused and dispersed but polarized to be concentrated in a specific direction. The light polarized by the first polarizing plate 200 travels to the second polarizing plate 500 through the first substrate 300 and the liquid crystal layer 400. The light polarized by the second polarizing plate 500 is finally provided to the light emitting layer 600 thus the light emitting layer 600 may emit light with a desired color.

The light emitted from the backlight unit 100 is concentrated without being diffused by the collimating film while passing through the first polarizing plate 200 so that intensity of the light may increase. Since the light with increased intensity passes through the first substrate 300 formed of thin glass, loss of light may be reduced.

That is, the light emitted from the backlight unit 100 is not dispersed by the first polarizing plate 200 but is concentrated in a specific direction so that the intensity of the light passes through the first substrate 300 formed of thin glass may be increased by minimizing the loss of light.

The light with the above characteristics is finally incident upon the light emitting layer 600 through the liquid crystal layer 400 and the second polarizing plate 500 so that a desired color is displayed. Since the light finally incident upon the light emitting layer 600 is not dispersed by the first polarizing plate 200 but is concentrated in a specific direction, the light may be incident upon only a desired pixel.

Therefore, the LCD according to the embodiment of the present inventive concept emits light only corresponding to a desired pixel by minimizing an amount of light indent upon a neighboring pixel, thus preventing crosstalk and improving picture quality.

In addition, in the LCD according to the embodiment of the present inventive concept, the second polarizing plate 500 including the magnetic particles 530 is arranged under the light emitting layer 600 so that it is possible to improve a polarization characteristic and to improve light efficiency.

Further, in the LCD according to the embodiment of the present inventive concept, the light emitting layer 600 including the optical conversion material such as the quantum dots, the quantum rods, and the phosphors is arranged under the second substrate 700 so that brightness of light may be increased.

Hereinafter, a method of manufacturing the upper display substrate 20 of the LCD having the above-described structure according to the embodiment of the present inventive concept will be described.

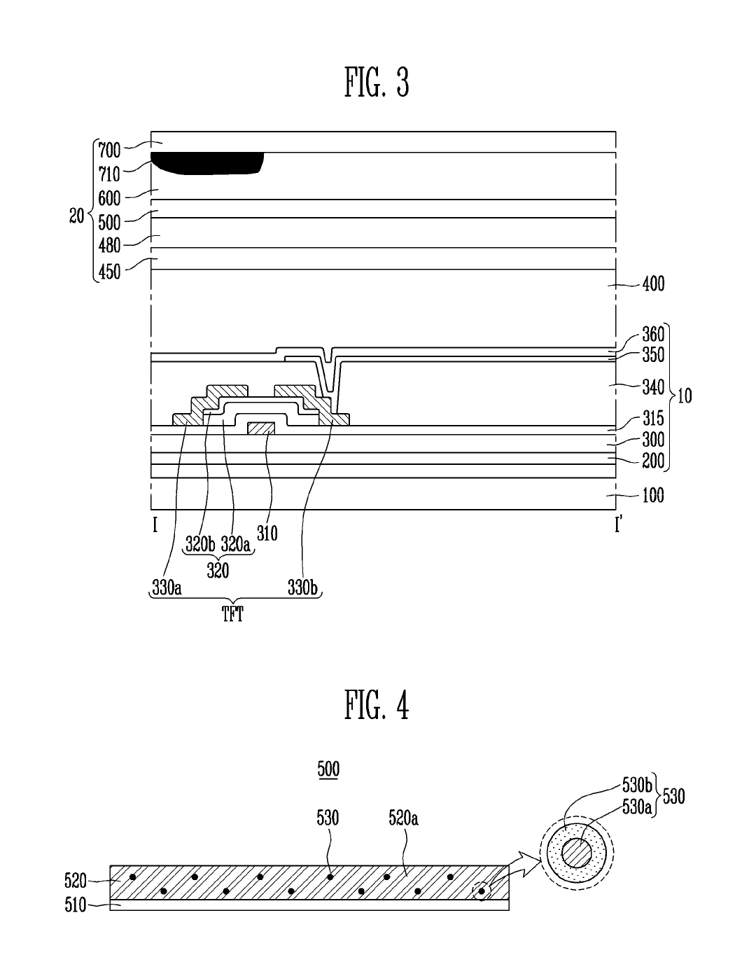

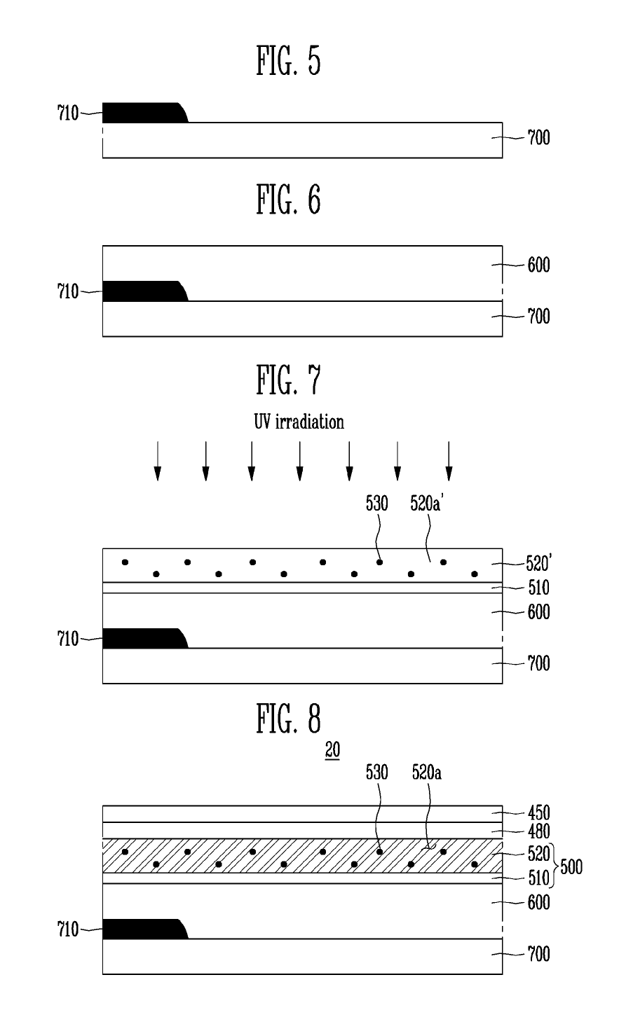

FIGS. 5 to 8 are cross-sectional views sequentially illustrating a method of manufacturing the upper display plate of FIG. 3.

Referring to FIG. 5, the black matrix 710 is formed on the second substrate 700.

Referring to FIG. 6, the light emitting layer 600 is formed on the second substrate 700 including the black matrix 710. The light emitting layer 600 may include the quantum dots or the quantum rods whose color changes in accordance with a size.

A quantum dot is formed of a core and a shell that surrounds the core. The core is formed of at least one of a group II-IV semiconductor including ZnS, ZnSe, ZnTe, CdS, CdSe, CdTe, HgS, HgSe, and HgTe, a group IV-VI semiconductor including PbS, PbSe, and PbTe, and a group III-V semiconductor including MN, AlP, AlAs, AlSb, GaN, GaP, GaAs, GaSb, InN, InP, InAs, and InSb.

Referring to FIG. 7, after forming the transparent substrate 510 on the light emitting layer 600 and thinly coating the transparent substrate 510 with a magnetic material layer 520′, the magnetic material layer 520′ is irradiated with the UV rays to be hardened so that the magnetic material layer 520 illustrated in FIG. 8 is formed. At this time, the transparent substrate 510 and the magnetic material layer 520 formed on the transparent substrate 510 form the second polarizing plate 500.

The magnetic material layer 520′ includes the plurality of magnetic particles 530 and the light hardening material 520a that fills spaces among the plurality of magnetic particles 530 and hardened by the UV irradiation. The light hardening material 520a is hardened by the UV irradiation to fix the plurality of magnetic particles 530 in the magnetic material layer 520′.

Then, the common electrode 480 and the second alignment layer 450 are sequentially formed on the second polarizing plate 500.

The total thickness of the liquid crystal panel may be determined in accordance with the thicknesses of the first and second substrates that form the liquid crystal panel. In particular, as the thickness of the first substrate on which the plurality of TFTs and the pixel electrode are formed becomes thicker, a distance between the backlight unit and the color filter increases.

When the distance between the backlight unit and the color filter increases, the light generated by the backlight unit may be dispersed while passing through the first substrate and the liquid crystal layer. Therefore, the light generated by the backlight unit does not only incident upon the color filter corresponding to the desired pixel but also incident upon a neighboring color filter so that crosstalk is generated and picture quality may deteriorate.

The LCD according to the embodiment of the present inventive concept emits only the light with the color corresponding to the desired pixel so that it is possible to minimize the amount of light incident upon the neighboring pixel, thus preventing crosstalk and improving picture quality.

In addition, in the LCD according to the embodiment of the present inventive concept, the second polarizing plate including the magnetic particles is arranged under the light emitting layer so that it is possible to improve a polarization characteristic and to improve light efficiency.

Example embodiments have been disclosed herein, and although specific terms are employed, they are used and are to be interpreted in a generic and descriptive sense only and not for a purpose of limiting the inventive concept. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present inventive concept as set forth in the following claims.

What is claimed is:

1. A liquid crystal display (LCD) comprising:
a thin film transistor (TFT) disposed on a first substrate;
a pixel electrode connected to the TFT;
a second substrate that faces the first substrate;
a liquid crystal layer formed between the first substrate and the second substrate;
a light emitting layer positioned between the liquid crystal layer and the second substrate;
a first polarizing plate positioned on a rear surface of the first substrate and including a collimating film; and
a second polarizing plate positioned between the light emitting layer and the liquid crystal layer.

2. The LCD of claim 1, wherein the first substrate has a thickness equal to or less than 200 μm.

3. The LCD of claim 1, wherein the light emitting layer comprises one selected from the group consisting of quantum dots, phosphors, and quantum rods.

4. The LCD of claim 1, wherein the second polarizing plate comprises an inorganic nano material having a magnetic characteristic.

5. The LCD of claim 4, wherein the inorganic nano material comprises Fe₃O₄.

6. The LCD of claim 1, wherein the second polarizing plate comprises a magnetic core and a transparent insulating material that surrounds the magnetic core.

7. The LCD of claim 6, wherein the second polarizing plate comprises a light hardening material disposed between the magnetic core.

8. The LCD of claim 7, wherein the light hardening material comprises polymer.

9. The LCD of claim 1, wherein the liquid crystal layer comprises a vertical alignment (VA) mode.

10. The LCD of claim 1, further comprising a common electrode formed between the second substrate and the light emitting layer.

11. A method of manufacturing an LCD, the method comprising:
forming a TFT and a pixel electrode connected to the TFT on a first substrate;
forming a first polarizing plate including a collimating film on a surface of the first substrate;
forming a light emitting layer on the second substrate;
forming a second polarizing plate on the light emitting layer; and
adhering the first substrate and the second substrate.

12. The method of claim 11, wherein the first polarizing plate is disposed on a rear surface of the first substrate.

13. The method of claim 12, wherein forming of a second polarizing plate on the light emitting layer comprises adding a light hardening material to a magnetic material and irradiating the obtained material with ultraviolet (UV) rays.

14. The method of claim 13, wherein the magnetic material comprises an inorganic nano material of Fe₃O₄.

15. The method of claim 12, wherein the second polarizing plate comprises a magnetic core and a transparent insulating material that surrounds the magnetic core.

16. The method of claim 12, wherein the first substrate has a thickness equal to or less than 200 μm.

17. The method of claim 12, wherein the light emitting layer comprises one selected from the group consisting of quantum dots, phosphors, and quantum rods.
